(19) United States
(12) Patent Application Publication
(10) Pub. No.: US 2021/0209217 A1
(43) Pub. Date: Jul. 8, 2021

(54) METHOD AND SYSTEM FOR AUTHENTICATION USING MOBILE DEVICE ID BASED TWO FACTOR AUTHENTICATION

(71) Applicant: Unity Technologies SF, San Francisco, CA (US)

(72) Inventors: Venkatesh Subramanian, Dublin, CA (US); Brandon Lee Caldwell, Duvall, WA (US); Jeffrey Moreno Collins, San Mateo, CA (US); Nirali Jayanti Savla, San Francisco, CA (US); Bryan Francis Grieco, Bothell, WA (US); Sami Heikki Pussinen, Helsinki (FI)

(21) Appl. No.: 17/140,951

(22) Filed: Jan. 4, 2021

Related U.S. Application Data
(60) Provisional application No. 62/957,031, filed on Jan. 3, 2020.

(51) Int. Cl. G06F 21/40; H04L 29/06

(52) U.S. Cl. CPC G06F 21/40; H04W 88/02; H04L 63/083

(57) ABSTRACT

A method of authenticating a user is disclosed. An authentication request is sent to a hot prevention service. The authentication request includes a device identification, a secondary form of user authentication, and an IP address. The authentication request excludes at least a portion of personally identifiable information associated with a user. A human verification test is received from the bot prevention service. The human verification test is performed. An answer associated with the test is sent to the bot prevention. service. An authentication approval or a failure of the authentication approval is received from the bot prevention service.

### CROSS-REFERENCE TO RELATED APPLICATIONS

This application claims the benefit of U.S. Provisional Application No. 62/957,031, filed Jan. 3, 2020, entitled “METHOD AND SYSTEM FOR AUTHENTICATION USING MOBILE DEVICE ID BASED TWO FACTOR AUTHENTICATION,” which is incorporated by reference herein it its entirety.

### TECHNICAL FIELD

The subject matter disclosed herein generally relates to the technical field of computer system security, and in one specific example, to computer systems and methods for providing security authentication for an individual while maintaining privacy of the individual.

### TECHNICAL BACKGROUND

Various tools exist to allow an online system or service provider to authenticate a user in order to allow the user access to access-controlled data. Existing authentication technologies require the user to first go through a registration process in order to create an identity for the user (e.g., in a database) prior to allowing the user access to the data. The identity stores information describing the user. Even existing authentication technologies that provide; a one-time password or identity are built upon a pre-existing registration process wherein the user has previously provided sufficient metadata to the authentication provider to build the identity which the provider later uses to authenticate with a password.

There are scenarios wherein the service provider may be required to share access-controlled data with the user in a trustworthy manner without much knowledge of the user (e.g., without a profile) and while maintaining privacy of the user (e.g., without collecting and storing unnecessary personal information from the user in order to build a profile). Existing authentication methods and systems do not cover such scenarios.

### BRIEF DESCRIPTION OF THE DRAWINGS

Further features and advantages of example embodiments of the present invention will become apparent from the following detailed description, taken in combination with the appended drawings, in which:

FIG. 1A is a schematic illustrating a device ID based two factor authentication system, in accordance with one embodiment;

FIG. 1B is a schematic illustrating a mobile device within a device ID based two factor authentication system, in accordance with one embodiment;

FIG. 2 is a flowchart of a method for device ID based two factor authentication, in accordance with one embodiment;

FIG. 3 is a sequence diagram of a method for device ID based two factor authentication, in accordance with one embodiment;

FIG. 4 is a block diagram illustrating an example software architecture, which may be used in conjunction with various hardware architectures described herein; and

FIG. 5 is a block diagram illustrating components of a machine, according to some example embodiments, configured to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that various embodiments of the inventive subject matter may be practiced without these specific details.

The terms ‘client’ and ‘application client’ used throughout the description herein are understood to include a software client or software application that can access data and services on a server, including accessing over a network.

The terms ‘Personally Identifiable Information’ and ‘PIT’ used throughout the description herein are understood to include data that can be used to identify an individual, including data considered personal data and data that can be used to deanonymize an individual and data that can be used to distinguish a first person from a second person.

The term ‘device ID’ used throughout the description herein is understood to include an identifier for a physical device (e.g., including mobile computing devices). The device ID also includes identifiers that link a physical device with a user account; for example, the device ID may include specific forms such as Apple's™ Identifier for Advertisers commonly referred to as the IDFA.

A method of authenticating a user is disclosed. An authentication request is sent to a bot prevention service. The authentication request includes a device identification, a secondary form of user authentication, and an IP address. The authentication request excludes at least a portion of personally identifiable information associated with a user. A human verification test is received from the bot prevention service. The human verification test is performed. An answer associated with the test is sent to the bot prevention service. An authentication approval or a failure of the authentication approval is received from the bot prevention service.

The present invention includes apparatuses which perform one or more operations or one or more combinations of operations described herein, including data processing systems which perform these methods and computer-readable media which when executed on data processing systems cause the systems to perform these methods, the operations or combinations of operations including non-routine or unconventional operations or combinations of operations.

Turning now to the drawings, systems and methods, including non-routine or unconventional components or operations, or combinations of such components or operations, for device ID based two-factor authentication in accordance with embodiments of the invention are illustrated.

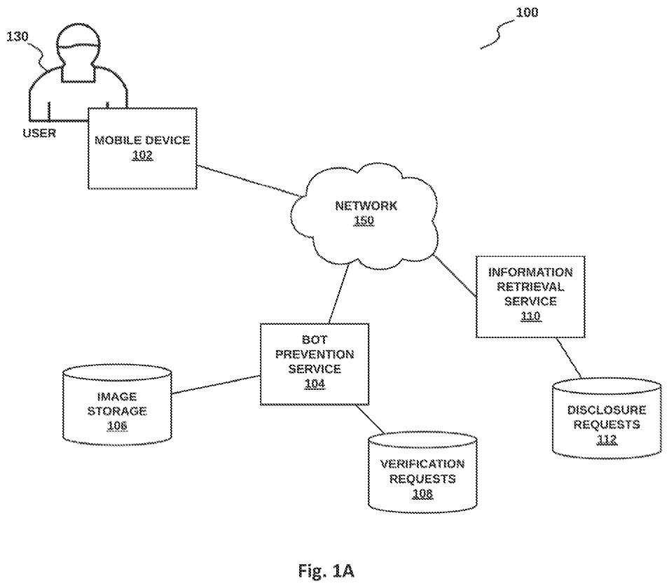

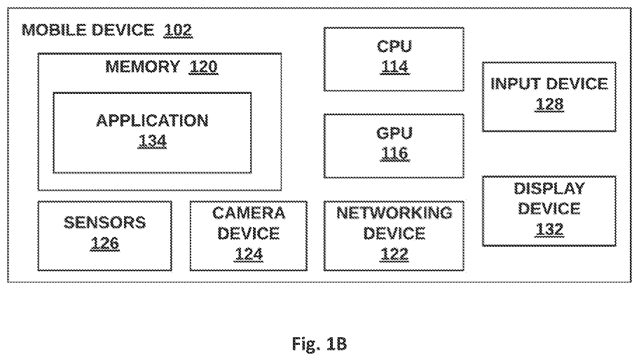

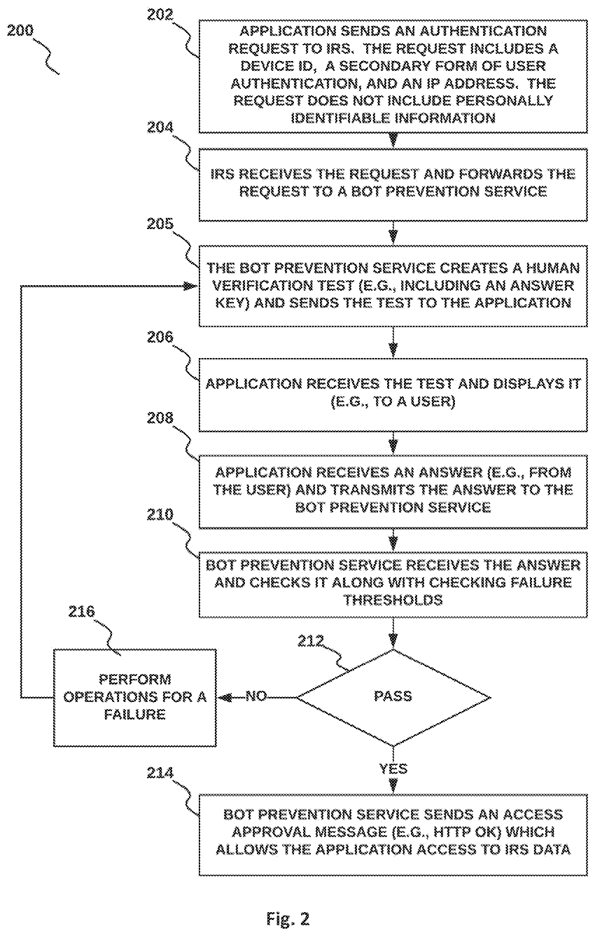

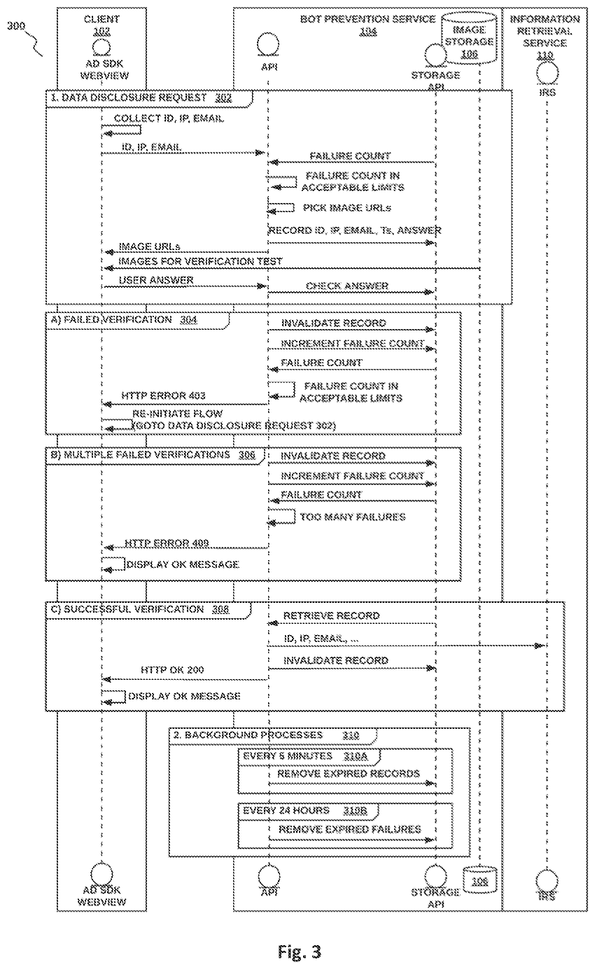

In accordance with many embodiments, and shown in FIG. 1A is a device ID based two-factor authentication system 100 (or simply the system 100). The system 100 includes a mobile device 102, a Bot Prevention Service 104, and an Information Retrieval Service 110 (or IRS 110) in networked communication over a network 150. In accordance with an embodiment, the Bot Prevention Service 104 provides a test for distinguishing between a human and a machine (e.g., including bots, artificial intelligence agents and computer programs). In accordance with an embodiment, the Bot Prevention Service ensures with reasonable accuracy that an authentication request is coming from a device with an authenticated device ID (e.g., for compliance). In accordance with an embodiment, the Bot Prevention Service ensures that an authentication request flow cannot be automated (e.g., for security). The Bot Prevention Service 104 can prevent bots from initiating and retrieving authentication requests. The Bot Prevention Service 104 can also make it difficult for users to spoof the authentication request flow. In accordance with an embodiment, the IRS 110 includes access controlled data (e.g., secure data, personal data, and the like). In accordance with an embodiment, the Bot Prevention Service 104 may be implemented as a device. In accordance with an embodiment, the Information Retrieval Service 110 may be implemented as a device. In accordance with an embodiment, while the Bot Prevention Service 104 and the Information Retrieval Service 110 may be shown separately in FIG. 1A, they may be implemented as one single device or service. In accordance with an embodiment, both the Bot Prevention Service 104 and the Information Retrieval Service 110 may be implemented with an application interface API for communication and data transfer in order to perform the operations as described in FIG. 2 and FIG. 3. In accordance with an embodiment, the system 100 includes an image storage database 106 which may include image data that may be required by the Bot Prevention Service 104. In accordance with an embodiment, the system 100 includes a verification request database 108 which may include data describing verification requests that may be required by the Bot Prevention Service 104. In accordance with an embodiment, the system 100 may include a disclosure request database 112 that includes data describing disclosure requests.

In accordance with an embodiment, FIG. 1A shows a single user 130 and a single mobile device 102; however, it should be understood that during operation, a plurality of users 130 on a plurality of mobile devices 102 may be in operation and in communication with the Bot Prevention Service 104 and the Information Retrieval Service 110 over the network 150.

In accordance with an embodiment, FIG. 1B is a schematic showing details of the mobile device 102. In some embodiments, the mobile device 102 is a mobile computing device, such as a smartphone or a tablet computer. In other embodiments, the mobile device 102 is a desktop or laptop computer. In accordance with an embodiment, the mobile device 102 includes one or more central processing units (CPUs) 114, and graphics processing units (GPUs) 116. The CPU 114 is any type of processor, processor assembly comprising multiple processing elements (not shown), having access to a memory 120 to retrieve instructions stored thereon, and execute such instructions. Upon execution of such instructions, the instructions cause the CPU 114 to perform a series of operations as described herein (e.g., in reference to FIG. 2 and FIG. 3). The mobile device 102 can also include one or more networking devices 122 (e.g., wired or wireless network adapters) for communicating over a network including a cellular network, a Wi-Fi network, the Internet, and so forth. The mobile device 102 further includes one or more camera devices 124 which may be configured to capture digital video of the real-world near the mobile device 102 during operation. The mobile device 102 may also include one or more sensors 126, such as a global positioning system (GPS) receiver (e.g., for determining a GPS location of the mobile device 102), biometric sensors (e.g., for capturing biometric data of the user 130), motion or position sensors (e.g., for capturing position data of the device 102, the user 130 and other objects), a depth sensor (e.g., LIDAR), and an audio microphone (e.g., for capturing sound data). Some sensors 126 may be external to the mobile device 102, and may be configured to wirelessly communicate with the mobile device 102 (e.g., such as used in the Microsoft Kinect®, Vive Tracker™, MIT's Lidar sensor, or MIT's wireless emotion detector).

The mobile device 102 may also include one or more input devices 128 such as, for example, a keyboard or keypad, mouse, pointing device, touchscreen, a microphone, a hand-held device or the like (e.g., hand motion tracking device) for inputting information in the form of a data signal readable by the CPU 114. The mobile device 102 further includes one or more display devices 132, such as a touchscreen of a tablet or smartphone, or lenses or visor of a virtual reality head-mounted display (HMD) or augmented reality HMD, which may be configured to display virtual objects to the user 130 in conjunction with a real-world view.

The mobile device 102 also includes a memory 120 configured to store instructions for an application 134. The memory 120 can be any type of memory device, such as random access memory, read-only or rewritable memory, internal processor caches, and the like. The application 134, executing on the mobile device 102, may be configured to capture data from the camera device 124, sensors 126, and input devices 128 to perform various functions as described with respect to FIG. 2 and FIG. 3. The application 134, executing on the mobile device 102, may be configured to provide a webview display via the display device 132.

In accordance with an embodiment, and shown in FIG. 2 is a method 200 for providing an authentication code for a user on a mobile device. In example embodiments, at least a portion of PII information associated with the user is not used. In example embodiments, a secondary form of user authentication (e.g., such as an email or phone number), an IP address, and/or a device ID is used. In accordance with an embodiment, the authentication code may be used for access to one or more of the following: an application on the mobile device, protected data on the mobile device, a service over the network 150, or protected data on an online service over the network 150. For example, in accordance with an embodiment, the method 200 shown in FIG. 2 allows the Information Retrieval Service 110 to use a unique, non-PII hardware-specific identifier to be associated with a pseudonymous identity (e.g., associated with the user 130), authenticate the identity, and allow only the identity to access protected data. In accordance with an embodiment, the method 200 shown in FIG. 2 provides a robust method for authentication of a user 130, wherein the method provides an authentication flow without requiring an initial registration process (e.g., creating a personal profile by providing PII) for the user 130. The method 200 includes the use of a hardware ID associated to a physical device (e.g., an Apple Inc. IDFA), coupled with two-factor authentication to provide a unique identity than can be reliably authenticated.

In accordance with an embodiment, the method 200 follows a two-factor authentication pattern. The method 200 includes a first form of identification using a device ID (e.g., an IDFA). Then the method 200 includes an in-app human verification (e.g., as described below with respect to operation 205, 206, 208 and 210) which acts as a temporary authentication method since it is rendered in the application 134 and is immediately associated with the device IDFA. In example embodiments, this flow can only be done through the application and cannot be spoofed as the application gets its IDFA from the operating system API. The in-app human verification also doubles as a bot-prevention method. Finally, the secondary identification is gathered from the user by requesting and storing an associated secondary form of user authentication.

In accordance with an embodiment, at operation 202 of the method 200, the application 134 creates and sends an authentication request to the Bot Prevention Service 104. The authentication request is a request by the application 134 on behalf of the user 130 to receive authentication for a purpose, wherein the purpose might include getting access to data (e.g., via the IRS 110), getting access to an application (e.g., on the mobile device 102), or getting access to a service (e.g., over the network 150). For example, the user 130 may request access to data that is protected with access control via the Information Retrieval Service 110 (e.g., via an online service provider). The request may include a device ID (e.g., an anonymous device ID), a secondary form of user authentication (e.g., an email or a phone number), and an IP address. The request excludes personally identifiable information (PII) other than the device ID, the secondary form of user identification, and the IP address. In accordance with an embodiment, the secondary form of user identification is associated with the user 130, the IP address is associated with the mobile device 102, and the device ID is associated with the mobile device 102 (and may also be associated with the user 130). The authentication request may be created due to an interaction of the user 130 with the application 134 executing on the CPU 114. In accordance with an embodiment, in operation 204 of the method, the IRS 110 receives the request and forwards the request to the Bot Prevention Service 104. In accordance with an embodiment, at operation 205, the Bot Prevention Service 104 creates a human verification test and sends the test to the application 134. In accordance with an embodiment, as part of operation 205, the Bot Prevention Service 104 creates an answer key for the test, wherein the answer key includes a correct answer for the test which is used to determine the validity of a response to the Lest (e.g., as part of operation 210).

In accordance with an embodiment, the human verification test is used to distinguish a human user 130 from a programming entity (e.g., a bot, an artificial agent, a machine input, or the like) in order to reduce or eliminate hacking attempts to access the data. In accordance with an embodiment the human verification test may use a plurality of methods for distinguishing a human from a computer or bot. For example, CAPTCHA (Completely Automated Public Turing test to tell Computers and Humans Apart) may be used for the human verification test, however CAPTCHA is optimized for web browsers and does not render well on applications running on a mobile device 102 (e.g., via a webview). In accordance with an embodiment, the human verification test includes a plurality of images and uses the human ability to identify an image (or part of an image) as the test. The human verification test may provide a plurality of images wherein only one of the provided images is predetermined as a correct answer. In accordance with an embodiment, as part of operation 205, when creating the human verification test, the test may include images from a public repository, wherein the images include randomized image names. The test may also include images from a plurality of distinct categories (e.g., animals, furniture, buildings, trees, and more). The test may also include images that have been resized and/or cropped to be of the same dimensions. In accordance with an embodiment, the Bot Prevention Service 104 may maintain an internal static mapping of image names to categories, but the application 134 will have no knowledge of the image categories through the entirety of the method 200 (e.g., the mapping is not included in the test sent to the application 134 as part of operation 205). As an example of a human verification test, the Bot Prevention Service 104 may include 16 image URLs, wherein the 16 images include 15 images from one category (e.g., different tree images) and 1 image from another category (e.g., image of dog), and wherein the categories are not disclosed within the test.

In accordance with an embodiment, the following human verification zest options may be used to increase an effectiveness of the human verification test (e.g., by reducing a probability of bot and hacker intervention): a) increase a number of images to be identified by the user 130 (e.g., 13 of one and 3 of the other, for example); b) increase a grid size of displayed images; c) include within the human verification test an image (e.g., a tree) and a list of text options (e.g., “tree”, “dog” etc.), and have the user 130 pick a text option that matches the image (e.g., in this case probability of bot and hacker intervention is limited by the number of text options shown).

In accordance with an embodiment, returning to FIG. 2, at operation 206 of the method 200, the application 134 receives the test and displays it via the display device 132 (e.g., to the user 130). For example, the application 134 may render images from the test within a webview (e.g., in a 4×4 grid of 16 images) with description text on an overlay. In accordance with an embodiment, at operation 208 of the method 200, the application 134 receives an answer (e.g., from the user 130) and transmits the answer to the Bot Prevention Service 104. The answer may be received via an input device 128, a sensor 116, a camera device 124, and a display device 132 (e.g., via a touchscreen). For example, the user may select (e.g., tap) a displayed image that is not similar to other displayed images. Based on the user 130 tapping an image, the application 134 may include the selected image name (e.g., or the image) as a parameter in the answer. In accordance with an embodiment, at operation 210 of the method 200, the Bot Prevention Service 104 receives the answer and determines the validity of the answer based on the answer key determined in operation 205. For example, the Bot Prevention Service 104 may validate an image name within the answer as belonging to a correct category. In accordance with an embodiment, as part of operation 210, the Bot Prevention Service 104 also checks failure thresholds (failure thresholds are defined below). At operation 214 of the method, based on a positive result for the validity test in operation 210 and based on a failure thresholds not being exceeded, the Bot Prevention Service 104 sends an access approval message to the application. In accordance with an embodiment, the access approval message includes an approval code (e.g., HTTP OK) which the application can use to access data (e.g., within the IRS). In accordance with an embodiment, at operation 216, based on a negative result for the validity test in operation 210, or based on the thresholds not being maintained, the Bot Prevention Service 104 sends a failure message to the application. In accordance with an embodiment, as part of operation 216, the method loops back to operation 205, creates a new test and performs operations 206, 208, and 210 for a predetermined number of times in order to give the user 130 the number of chances to correctly answer the test before reaching a failure threshold. For example, based on a user 130 tapping an incorrect image, the user 130 may be notified of the failure and a new set of images will be shown for verification within a new human verification test; furthering the example, after a predetermined number of failed attempts, the user 130 will only be allowed to send another request after a period of time (e.g., 24 hours).

Load Balancer

In accordance with an embodiment, a load balancer may be used at operation 216 (e.g., based on a test failure) in order to increase security by throttling an endpoint (e.g., an IP address, a mobile device). Based on a determination that a single IP address provides a number of requests above a predetermined threshold, the load balancer may throttle the IP address and block access (e.g., access to data, access to an application, access to a service, or the like) for the IP address. In accordance with an embodiment, based on a number of requests from the single IP address being above the predetermined threshold, the single IP address may be flagged for manual review. In addition, the content of one or more requests from the single IP address may also be flagged for review.

Delay Between Request and Access

In accordance with an embodiment, as part of operation 202 and 210 of the method 200, the following metrics are recorded in addition to other parameters in a request: an IP address of the source of the request, a timestamp related to the request, and a Pass/Fail on the in-app human verification (e.g., as part of operation 210). In accordance with an embodiment, the above metrics have associated failure thresholds. Requests that exceed failure thresholds for the metrics will not receive access approval (e.g., at operation 214) and may be flagged for manual verification. In accordance with an embodiment, there is provided a failure threshold that describes a maximum number of incorrect human verification attempts (e.g., at operation 208) from a single IP address. In accordance with an embodiment, there is a failure threshold that describes a maximum number of requests from a single IP address within a time period. In accordance with an embodiment, there is a failure threshold that describes a maximum number of requests that include a same secondary form of user authentication (e.g., a single email address). In accordance with an embodiment, as part of operation 216 of the method 200, a delay may be placed on a request that is flagged, allowing time for a manual review process. In accordance with an embodiment, a manual review process may include the following: blocking the IP from making requests for a period of time, and sending a message (e.g., an email, a text, a voice message, or the like) to the secondary form of user authentication within the request, wherein the message includes instructions to the user 130 associated with the request. In other embodiments, as part of operation 216 of the method, an increasing time delay may be used before a user 130 can make additional requests following an incorrect choice within the human verification test (e.g., causing a failed verification).

In accordance with an embodiment, and shown in FIG. 3 is a sequence diagram detailing aspects of a method 300 for providing an authentication code for a user on a mobile device, wherein the authentication code allows access (e.g., to data) on an online service over the network 150, and wherein the user does not provide PII information in addition to a secondary form of user authentication, an IP address and a device ID. The method 300 may be similar to the method described in FIG. 2 wherein additional detail is provided. For example, in accordance with an embodiment, the data disclosure request loop 302 shows some example details of sequences related to operations 202, 204, 205, 206, 208, and 210 of the method 200. In addition, the failed verification loop 304 and the multiple failed verifications loop 306 shown in FIG. 3 include example details of sequences related to operation 216 of the method 200, including operations performed during one or more failed verifications. Furthermore, the successful verification loop 308 shown in FIG. 3 includes example details of sequences included in operation 214 of the method 200, wherein a verification is successful. In accordance with an embodiment, and shown in FIG. 3, there is included background processes 310 (e.g., not specifically included in the method 200 shown in FIG. 2) for removing expired records 310A and removing expired failures 310B over time.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer-readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between, or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance Gf the relevant operations in a “cloud computing” environment or as a “software as a service” (SaaS). For example, at least some of the operations may be performed by a group of computers (as examples of machines including processors), with. these operations being accessible via. a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

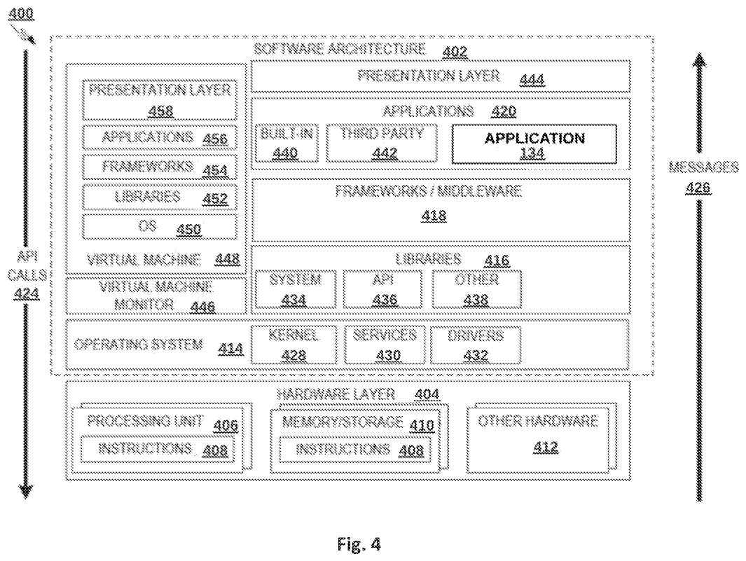

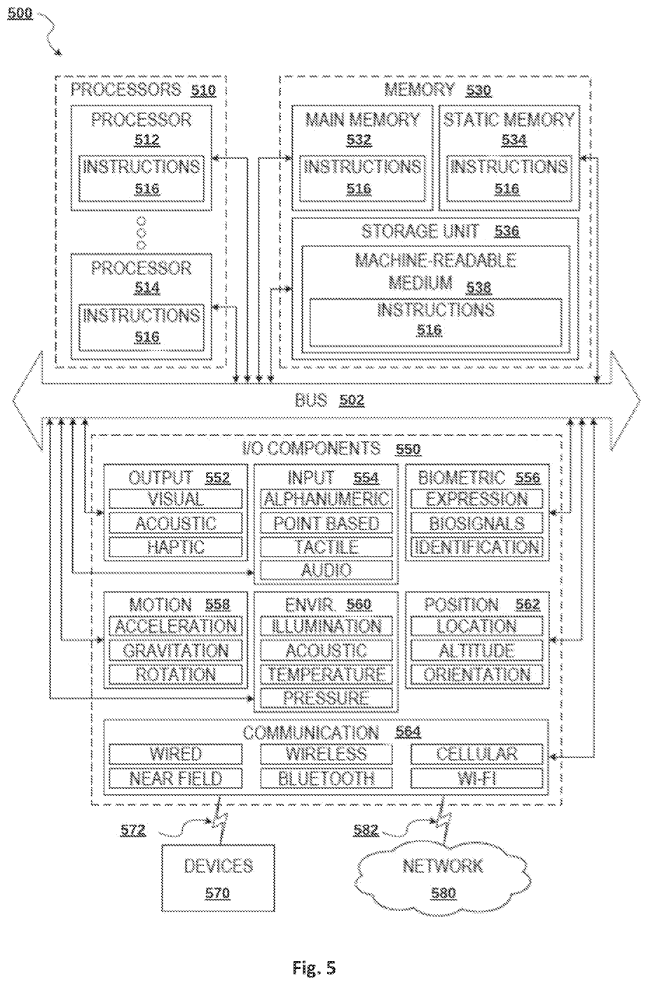

FIG. 4 is a block diagram 400 illustrating an example software architecture 402, which may be used in conjunction with various hardware architectures herein described to provide a gaming engine 401 and/or components of the system 100. FIG. 4 is a non-limiting example of a software architecture and it will be appreciated that many other architectures may be implemented to facilitate the functionality described herein. The software architecture 402 may execute on hardware such as a machine 500 of FIG. 5 that includes, among other things, processors 510, memory 530, and input/output (I/O) components 550. A representative hardware layer 404 is illustrated and.

can represent, for example, the machine 500 of FIG. 5. The representative hardware layer 404 includes a processing unit 406 having associated executable instructions 408. The executable instructions 408 represent the executable instructions of the software architecture 402, including implementation of the methods, modules and so forth described herein. The hardware layer 404 also includes memory/storage 410, which also includes the executable instructions 408. The hardware layer 404 may also comprise other hardware 412.

In the example architecture of FIG. 4, the software architecture 402 may be conceptualized as a stack of layers where each layer provides particular functionality. For example, the software architecture 402 may include layers such as an operating system 414, libraries 416, frameworks or middleware 418, applications 420 and a presentation layer 444. Operationally, the applications 420 and/or other components within the layers may invoke application programming interface (API) calls 424 through the software stack and receive a response as messages 426. The layers illustrated are representative in nature and not all software architectures have all layers. For example, some mobile or special purpose operating systems may not provide the frameworks/middleware 418, while others may provide such a layer. Other software architectures may include additional or different layers.

The operating system 414 may manage hardware resources and provide common services. The operating system 414 may include, for example, a kernel 428, services 430, and drivers 432. The kernel 428 may act as an abstraction layer between the hardware and the other software layers. For example, the kernel 428 may be responsible for memory management, processor management (e.g., scheduling), component management, networking, security settings, and so on. The services 430 may provide other common services for the other software layers. The drivers 432 may be responsible for controlling or interfacing with the underlying hardware. For instance, the drivers 432 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 416 may provide a common infrastructure that may be used by the applications 420 and/or other components and/or layers. The libraries 416 typically provide functionality that allows other software modules to perform tasks in an easier fashion than to interface directly with the underlying operating system 414 functionality (e.g., kernel 428, services 430 and/or drivers 432). The libraries 416 may include system libraries 434 (e.g., C standard library) that may provide functions such as memory allocation functions, string manipulation functions, mathematic functions, and the like. In addition, the libraries 416 may include API libraries 436 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 416 may also include a wide variety of other libraries 438 to provide many other APIs to the applications 420 and other software components/modules.

The frameworks 418 (also sometimes referred to as middleware) provide a higher-level common infrastructure that may be used by the applications 420 and/or other software components/modules. For example, the frameworks/middleware 418 may provide various graphic user interface (GUI) functions, high-level resource management, high-level location services, and so forth. The frameworks/middleware 418 may provide a broad spectrum of other APIs that may be utilized by the applications 420 and/or other software components/modules, some of which may be specific to a particular operating system or platform.

The applications 420 include built-in applications 440 and/or third-party applications 442. Examples of representative built-in applications 440 may include, but are not limited to, a contacts application, a browser application, a book reader application, a location application, a media application, a messaging application, and/or a game application. Third-party applications 442 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 442 may invoke the API calls 424 provided by the mobile operating system such as operating system 414 to facilitate functionality described herein.

The applications 420 may use built-in operating system functions (e.g., kernel 428, services 430 and/or drivers 432), libraries 416, or frameworks/middleware 418 to create user interfaces to interact with users of the system. Alternatively, or additionally, in some systems, interactions with a user may occur through a presentation layer, such as the presentation layer 444. In these systems, the application/module “logic” can be separated from the aspects of the application/module that interact with a user.

Some software architectures use virtual machines. In the example of FIG. 4, this is illustrated by a virtual machine 448. The virtual machine 448 creates a software environment where applications/modules can execute as if they were executing on a hardware machine (such as the machine 500 of FIG. 5, for example). The virtual machine 448 is hosted by a host operating system (e.g., operating system 414) and typically, although not always, has a virtual machine monitor 446, which manages the operation of the virtual machine 448 as well as the interface with the host operating system (i.e., operating system 414). A software architecture executes within the virtual machine 448 such as an operating system (OS) 450, libraries 452, frameworks 454, applications 456, and/or a presentation layer 458. These layers of software architecture executing within the virtual machine 443 can be the same as corresponding layers previously described or may be different.

FIG. 5 is a block diagram illustrating components of a machine 500, according to some example embodiments, configured to read instructions from a machine-readable medium (e.g., a machine-readable storage medium) and perform any one or more of the methodologies discussed herein. In some embodiments, the machine 500 is similar to the mobile device 102. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. As such, the instructions 516 may be used to implement modules or components described herein. The instructions transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines that individually or jointly execute the instructions 516 to perform any one or more of the methodologies discussed herein.

The machine 500 may include processors 510, memory 530, and input/output (I/O) components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 512 and a processor 514 that may execute the instructions 516. The term “processor” is intended to include multi-core processor that may comprise two or more independent processors (sometimes referred to as “cores”) that may execute instructions contemporaneously. Although FIG. 5 shows multiple processors, the machine 500 may include a single processor with a single core, a single processor with multiple cores (e.g., a multi-core processor), multiple processors with a single core, multiple processors with multiples cores, or any combination thereof.

The memory/storage 530 may include a memory, such as a main memory 532, a static memory 534, or other memory, and a storage unit 536, both accessible to the processors 510 such as via the bus 502. The storage unit 536 and memory 532, 534 store the instructions 516 embodying any one or more of the methodologies or functions described herein. The instructions 516 may also reside, completely or partially, within the memory 532, 534, within the storage unit 536, within at least one of the processors 510 (e.g., within the processor's cache memory), or any suitable combination thereof, during execution thereof by the machine 500. Accordingly, the memory 532, 534, the storage unit 536, and the memory of processors 510 are examples of machine-readable media 533.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM;) and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks chat include multiple storage apparatus or devices. The term “machine-readable medium” excludes signals per se.

The input/output (I/O) components 550 may include a wide variety of components to receive input, provide output, produce output, transmit information, exchange information, capture measurements, and so on. The specific input/output (I/O) components 550 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 550 may include many other components that are not shown in FIG. 5. The input/output (I/O) components 550 are grouped according to functionality merely for simplifying the following discussion and the grouping is in no way limiting. In various example embodiments, the input/output (I/O) components 550 may include output components 552 and input components 554. The output components 552 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect, air pressure from which altitude may be derived), orientation sensor components (e.g., magnetometers), and the like.

Communication may be implemented using a wide variety of technologies. The input/output (I/O) components 550 may include communication components 564 operable to couple the machine 500 to a network 530 or devices 570 via a coupling 532 and a coupling 572 respectively. For example, the communication components 564 may include a network interface, component or other suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a Universal Serial Bus (USB)).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RS3-2D bar code, and other optical codes), or acoustic detection components (e.g., microphones to identify tagged audio signals). In addition, a variety of information may be derived via the communication components 562, such as, location via Internet Protocol (IP) geo-location, location via Wi-Fi(c) signal triangulation, location via detecting a NFC beacon signal that may indicate a particular location, and so forth.

Throughout this specification, plural instances may implement, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

1. A system comprising:
one or more computer processors;
one or more computer memories;
a set of instructions incorporated into the one or more computer memories, the set of instructions configuring the one or more computer processors to perform operations comprising:
sending an authentication request to a bot prevention service, the authentication request including a device identification, a secondary form of user authentication, and an IP address, the authentication request excluding at least a portion of personally identifiable information associated with a user;
receiving a human verification test from the hot prevention service;
performing the human verification test;
sending an answer associated with the test to the bot prevention service;
receiving an authentication approval or a failure of the authentication approval from the bot prevention service.

2. The system of claim 1, wherein the human verification test includes using an image-based human verification test configured for a mobile device.

3. The system of claim 1, wherein the authentication request includes an anonymous identifier.

4. The system of claim 1, wherein the authentication approval includes providing an access code that may be used to access one or more of the following: an application on the mobile device, a service over the network, data on the mobile device, and data over the network.

5. The system of claim 1, based on a receiving of the failure of the authentication approval, performing at least one of blocking the IP address permanently, blocking the IP address for a period of time, blocking the secondary form of user authentication, or performing a new human verification test.

6. The system of claim 1, wherein the secondary form of user authentication includes one or more of an email address and a phone number.

7. The system of claim 1, further comprising, based on a receiving of the authentication approval, providing access to data within an information retrieval service.

8. A method comprising:
sending an authentication request to a bot prevention service, the authentication request including a device identification, a secondary form of user authentication, and an IP address, the authentication request excluding at least a portion of personally identifiable information associated with a user;
receiving a human verification test from the bot prevention service;
performing the human verification test;
sending an answer associated with the test to the hot prevention service;
receiving an authentication approval or a failure of the authentication approval from the hot prevention service

9. The method of claim 8, wherein the human verification test includes using an image-based human verification test configured for a mobile device.

10. The method of claim 8, wherein the authentication request includes an anonymous identifier.

11. The method of claim 8, wherein the authentication approval includes providing an access code that may be used to access one or more of the following: an application on the mobile device, a service over the network, data on the mobile device, and data over the network.

12. The method of claim 8, based on a receiving of the failure of the authentication approval, performing at least one of blocking the IP address permanently, blocking the IP address for a period of time, blocking the secondary form of user authentication, or performing a new human verification test.

13. The method of claim 8, wherein the secondary form of user authentication includes one or more of an email address and a phone number.

14. The method of claim 8, further comprising, based on a receiving of the authentication approval, providing access to data within an information retrieval service.

15. A non-transitory computer-readable storage medium storing a set of instructions that, when executed by one or more processors, causes the one or more computer processors to perform operations comprising:
sending an authentication request to a bot prevention service, the authentication request including a device identification, a secondary form of user authentication, and an IP address, the authentication request excluding at least a portion of personally identifiable information associated with a user;
receiving a human verification test from the bot prevention service;
performing the human verification test;
sending an answer associated with the test to the bot prevention service;
receiving an authentication approval or a failure of the authentication approval from the bot prevention service.

16. The non-transitory computer-readable storage medium of claim 15, wherein the human verification test includes using an image-based human verification test configured for a mobile device.

17. The non-transitory computer-readable storage medium of claim 15, wherein the authentication request includes an anonymous identifier.

18. The non-transitory computer-readable storage medium of claim 15, wherein the authentication approval includes providing an access code that may be used to access one or more of the following: an application on the mobile device, a service over the network, data on the mobile device, and data over the network.

19. The non-transitory computer-readable storage medium of claim 15, based on a receiving of the failure of the authentication approval, performing at least one of blocking the IP address permanently, blocking the IP address for a period of time, blocking the secondary form of user authentication, or performing a new human verification test.

20. The non-transitory computer-readable storage medium of claim 15, wherein the secondary form of user authentication includes one or more of an email address and a phone number.
